(19) United States
(12) Patent Application Publication
(10) Pub. No.: US 2024/0028924 A1
(43) Pub. Date: Jan. 25, 2024

(54) SYSTEMS AND METHODS FOR PREDICTING PERFORMANCE METRICS USING COHORTS

(71) Applicant: Change Healthcare Holdings, LLC, Nashville, TN (US)

(72) Inventor: Eldon A. Wong, Vancouver (CA)

(21) Appl. No.: 17/813,670

(22) Filed: Jul. 20, 2022

(51) Int. Cl. G06N 5/04

(52) U.S. Cl. CPC G06N 5/04

(57) ABSTRACT

Systems and methods for estimating a performance metric based on cohorts are provided. One or more performance metrics with respect to an application are monitored for entities over time. Entities with similar performance metrics are grouped into cohorts. Characteristics of a computing environment for each entity are determined. The characteristics of the entities in each cohort are used to define the characteristics of the cohort. Later, when a new entity inquires about the performance metrics that the entity could expect, the characteristics of the computing environment of the new entity are determined and are used to determine the cohort that the new entity belongs to. The average performance metrics of the entities in the determined cohort can be return to the new entity as the expected performance metrics.

### BACKGROUND

More and more services such as applications are moving from locally hosted solutions to cloud-based solutions. For applications involving the use of large files, such as medical imaging, entities may desire to know what kind of performance they can expect from a cloud-based service provider before moving to a cloud-based solution.

For example, a hospital may currently use a medical imaging application that is hosted on a local server and serves locally stored medical images (e.g., X-Rays and MRIs) to local users. Before switching to a cloud-based medical image streaming application, the hospital may desire that the application provider provide estimates of the speeds at which the hospital users can expect to receive medical images.

Currently, application providers provide performance estimates (metrics) that are based on the bandwidth of the Internet connection used by the entity. However, there are many other factors that can affect the performance of a cloud-based application for an entity besides internet bandwidth.

### SUMMARY

In an embodiment, systems and methods for estimating a performance metric based on cohorts are provided. One or more performance metrics with respect to an application are monitored for entities over time. Entities with similar performance metrics are grouped into cohorts. Characteristics of a computing environment for each entity are determined such as internet bandwidth, distance to cloud-server, internal computing resources, average number of users, average number or size of files served, and whether or not the entity uses a firewall. The characteristics of the entities in each cohort are used to define the characteristics of the cohort. Later when a new entity inquires about the performance metrics that the entity could expect, the characteristics of the computing environment of the new entity are determined and are used to determine the cohort that the new entity belongs to. The average performance metrics of the entities in the determined cohort can be returned to the new entity as the expected performance metrics.

The systems and methods described herein provide the following advantages. First, because cohorts are used to estimate performance metrics for an entity instead of just bandwidth, the entity may receive a more accurate estimate of performance metrics than previous systems. Second, when an entity is determined to be receiving lower than expected performance when compared to a cohort average, the performance of the other entities in the cohort can be measured and used to determine if the low performance is due to an isolated entity-specific issue or is common to many of the entities in the cohort.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying figures, which are incorporated herein and form part of the specification, illustrate systems and methods for estimating performance metrics using cohorts. Together with the description, the figures further serve to explain the principles of the systems and methods for estimating performance metrics using cohorts described herein and thereby enable a person skilled in the pertinent art to make and use the systems and methods for estimating performance metrics using cohorts.

FIG. 1 is an example environment for estimating performance metrics using cohorts;

FIG. 2 is an illustration of an example method for assigning entities to cohorts;

FIG. 3 is an illustration of an example method for estimating a performance metric for an entity based on cohorts;

FIG. 4 is an illustration of an example method for identifying entities with computing environment issues;

FIG. 5 is an illustration of an example method for reassigning entities based on cohorts; and

FIG. 6 shows an example computing environment in which example embodiments and aspects may be implemented.

### DETAILED DESCRIPTION

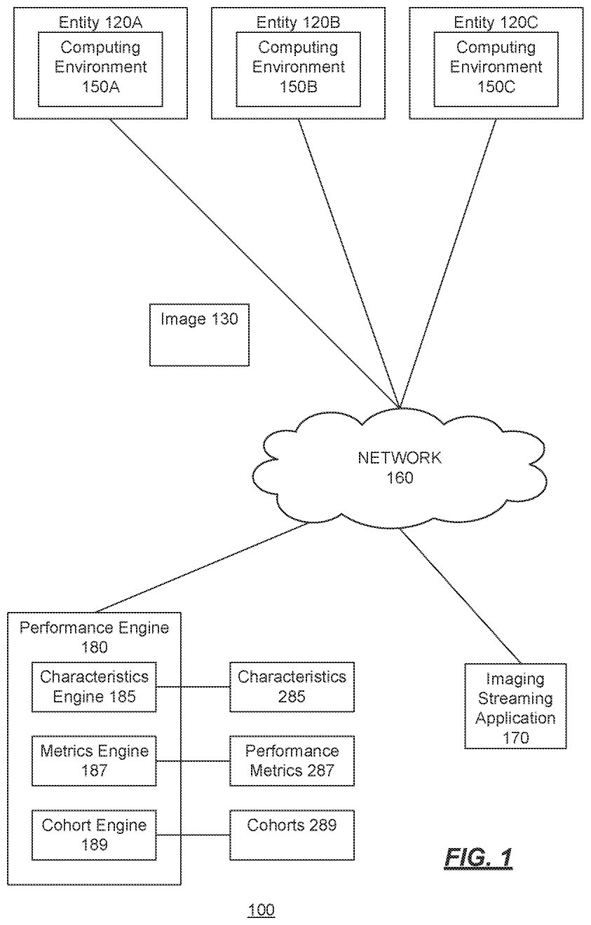

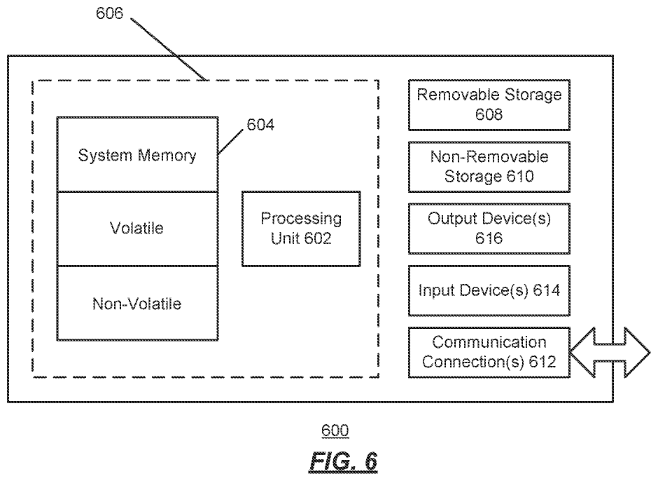

FIG. 1 is an example environment for estimating performance metrics using cohorts. As shown, the environment 100 may include one or more entities 120 (e.g., the entities 120A, 120B, and 120C), an image streaming application 170, and a performance engine 180 in communication through a network 160. The network 160 may include a combination of private networks (e.g., LANs) and public networks (e.g., the Internet). Each of the entities 120, the image streaming application 170, and the performance engine 180 may use, or may be partially implemented by, one or more general purpose computing devices such as the computing device 600 illustrated in FIG. 6.

The image streaming application 170 may be a medical image streaming application 170 and may store and provide images 130 to the entities 120. The image streaming application 170 may be a cloud-based application.

Each entity 120 may use the image streaming application through the network 160. Each entity 120 may be associated with a computing environment 150 (e.g., the computing environments 150A, 150B, and 150C). The computing environment 150 as used herein may include characteristics 285 that describe the computing and networking capabilities of each entity 120 including available resources, available computing and networking devices used, and the number of users associated with the entity 120. Example characteristics of the computing environment 150 may include, but are not limited to, location characteristics (e.g., the country, city, state, or region that the entity 120 located in, or distance from the closest cloud-server or associated cloud-data center to the entity 120), network characteristics (e.g., the network speed to the cloud-server from the entity 120, the ISP used by the entity 120, the internal speed of the network 160—associated with the entity 120, whether the entity use a load balancer or a firewall, and the average usage of the network 160 associated with entity 120), workload characteristics (e.g., the number of users that are associated with the entity 120, and the volume of images 130 used by the entity 120 in a year, month, week, or day), and computing resource characteristics (e.g., the types of boundary servers used by the entity 120, and the types of computers used by the application 170). Other characteristics 285 may be supported for the computing environment 150.

In some embodiments, to assist in estimating performance metrics for a new entity 120 using cohorts, the environment 100 may further include the performance engine 180. As shown the performance engine 180 includes several components, including but not limited to, a characteristics engine 185, a metrics engine 187, and a cohort engine 189. More or fewer components may be supported. The performance engine 180 may be implemented using one or more computers associated with a cloud-based computing environment. Note that while the performance engine 180 is shown as separate from the image streaming application 170, it is for illustrative purposes only. In some embodiments, the performance engine 180 may be part of the image streaming application 170 and/or executed in the same cloud-computing environment.

The characteristics engine 185 may collect characteristics 285 for a computing environment 150 for each entity 120 that uses the image streaming application 170. In some embodiments, the characteristics engine 185 may collect some or all of the characteristics 285 for an entity 120 using a survey or questionnaire that is provided to the entity 120. The questionnaire may ask the entity 120 questions related to characteristics 285 such as their location, their ISP, their expected number of users, their expected volume of images 130, etc.

In some embodiments, the characteristics engine 185 may collect the characteristics 285 for an entity 120 from the image streaming application 170. For example, the imagining application 170 may provide observed characteristics 285 such as image 130 volume, average number of users, and average network speed.

In some embodiments, the characteristics engine 185 may install an application or network appliance at the location of the entity 120. The application or network appliance may collect characteristics 285 of the entity 120 such as network and computing resource characteristics. The application or network appliance may provide the collected characteristics 285 periodically to the characteristics engine 185 through the network 160.

The metrics engine 187 may generate one or more performance metrics 287 for some or all of the entities 120. In some embodiments, the performance metrics 287 generated for an entity 120 may include one or more of response time, bandwidth, throughput, latency, availability (e.g., percentage of successful/failed requests), reliability (e.g., mean time between failures), and cost rate (e.g., amount being “charged” for each entity or pricing structure). In addition, domain specific (e.g., medical studies) performance metrics may be considered such as study turn-around time, total studies completed, total peer reviews, total studies flagged per peer review, and average time to start working on a study. Other metrics 287 may be considered.

The metrics engine 187 may generate the performance metrics 287 for an entity 120 by monitoring the interactions between the entity 120 and the image streaming application 170. In some embodiments, the metrics engine 187 may monitor the interactions between the entity 120 and the image streaming application 170 by interfacing with one or both of the entity 120 and the image streaming application 170. For example, the metrics engine 187 may monitor the entity 120 using an application or network appliance that is installed at a location of the entity 120 or image streaming application 170. Other methods for collecting data to generate performance metrics 287 may be used.

In some embodiments, the metrics engine 187 may determine performance metrics 287 for an entity 120 by observing actual usage of the image streaming application 170 over some period or periods of time. In other embodiments, the metrics engine 187 may determine the performance metrics 287 for an entity 120 using a controlled or predetermined process. For example, the metrics engine 187 may cause the entity 120 to retrieve a sequence of known images 130 having a variety of sizes and may determine the performance metrics 287 based on the performance of the image streaming application 170 for the entity 120 while retrieving the sequence of known images 130. Using a controlled process to determine the performance metrics 287 for each entity 120 may provide more accurate and reliable performance metrics 287.

In some embodiments, the metric engine 187 may use context data determined while monitoring the streaming application 170 to generate performance metrics. For example, when the status of a study on the streaming application 170 changes to “completed”, the metric engine 187 may use a start time and end time associated with the study to determine a metric 287 such as study turn-around time.

The cohort engine 189 may divide the entities 120 into one or more cohorts 289. A cohort 289 as used herein is a grouping of two or more entities 120 having similar performance metrics 287 and/or computing environment characteristics 285. As will be described further below, the entities 120 in a cohort 289 may be used to predict performance metrics 287 for new or prospective entities 120, and to determine whether detected performance issues are entity 120 specific or more broadly associated with the entities 120 in a cohort 289.

In some embodiments, the cohort engine 189 may divide entities 120 into cohorts 289 based on similar performance metrics 287. For example, entities 120 with a throughput of around 3 mb/s may be divided into a first cohort 289, entities 120 with a throughput of around 5 mb/s may be divided into a second cohort 289, and entities 120 with a throughput of around 7 mb/s may be divided into a third cohort 289. The number of cohorts 289 and the criteria used for each cohort 289 may be set by a user or administrator.

In some embodiments, an entity 120 may be placed in a cohort 289 when its associated performance metric 287 is within a threshold percentage of the performance metric 287 associated with the cohort 289. For example, a cohort 289 may have a performance metric 287 of a throughput of 7 mb/s. If the threshold percentage is 20%, then entities 120 having throughputs of between 5.6 mb/s and 8.4 mb/s may be assigned to the cohort 289. The threshold percentage may be set by a user or administrator.

In some embodiments, in addition to performance metrics 287, entities 120 may be divided into cohorts 189 based on one or more characteristics of the computing environments 150 associated with each entity 120. For example, entities 120 may be divided into cohorts 289 based on characteristics 285 such as distance from the cloud-computing environment or ISP.

After assigning the entities 120 to cohorts 289, some or all of the characteristics 285 associated with the entities 120 in a cohort 289 may also be associated with the cohort 289. As will be described further below, the characteristics 285 associated to each cohort 289 may be later used to determine which cohort 289 to use to predict the performance metrics 287 for a new or prospective cohort 289.

In some embodiments, the cohort engine 189 may assign the characteristic 285 of each entity 120 to the cohort 289 that it is associated with. Alternatively, the cohort engine 189 may determine the characteristics 285 that are associated with a majority (or some percentage) of the entities 120 in the cohort 289 and may assign those characteristics 285 to the cohort 120. The percentage may be set by a user or administrator.

After establishing the cohorts 289, the cohort engine 189 may periodically adjust or reassign some of the entities 120 in each cohort 289. In some embodiments, the cohort engine 189 may use the performance metrics 287 provided by the metrics engine 187 to determine that the performance metric 287 of an entity 120 associated with cohort 289 deviates from the performance metric 287 associated with the cohort 289. For example, an entity 120 may have a throughput of 2 mb/s and the throughput of the cohort 289 may be 8 mb/s.

In response, the cohort engine 189 may reassign the entity 120 to a different cohort 289 (i.e., cohort 289 whose performance metric 287 is within a threshold percentage of the performance metric 287 of the entity 120). After moving the entity 120, the cohort engine 189 may adjust the characteristics 285 of both the original cohort 289 and the new cohort 289 based on the characteristics of the entity 120.

In some embodiments, an entity 120 may be reassigned to a different cohort 289 after its associated performance metric 287 deviates from the performance metric 287 associated with the cohort 289 by the threshold percentage more than some number of times over some window of time. For example, the cohort engine 189 may monitor the performance metric 287 of an entity 120 over a window of time such as a day. If the performance metric 287 deviates from the performance metric 287 of the associated cohort 289 more than five times, then the entity 120 may be reassigned. Else, the entity 120 may remain in the assigned cohort 289. The window size and number of deviations may be selected by a user or administrator.

The cohort engine 189 may use the cohorts 289 to predict the performance metric 287 for a new entity 120 that would like to use the image streaming application 170. To predict the performance metrics 287 for a new entity 120, as a first step the characteristic engine 185 may determine characteristics 285 of the computing environment 150 associated with the new entity 120. For example, the characteristics engine 185 may present the new entity with a questionnaire that asks the new entity 120 to provide information that may be used to determine characteristics 285 of their associated computing environment 150. For example, the questionnaire may ask for the ISP of the new entity 120, the distance of the entity 120 from the cloud-environment, the types of images 130 that they expect to view; and the number of images 130 that they expect to view. Other questions may be included in the questionnaire. In addition, the characteristics engine 185 may install an application or network appliance at the new entity 120 that may determine some of the characteristics 285 of the computing environment 150.

After determining the characteristics 285 of the new entity 120, the cohort engine 189 may determine a cohort 289 with characteristics 285 that most closely match the characteristics of the new entity 120. Where multiple cohorts 289 match, or no cohort 289 matches, the cohort engine 189 may select a cohort 289 based on a particular characteristic 285 such as distance from the cloud-environment, name or type of ISP, and network bandwidth.

After determining the cohort 289 that best matches the new entity 120, the cohort engine 189 may determine performance metrics 287 associated with the cohort 289 and may return or provide the performance metrics 287 to the entity 120 as the predicted performance metrics 287 for the entity 120. Depending on the embodiment, the cohort engine 189 may determine the performance metrics 287 for the cohort 289 by determining the performance metrics 287 for each entity 120 in the cohort 289. The cohort engine 189 may determine the average performance metrics 287 of the entities 120 (e.g., mean, median, or mode) as the performance metrics 287 for the cohort 289.

The cohorts engine 189 may use the cohorts 289 to diagnose or investigate poor performance metrics 287. When a below average or poor performance metric 287 is detected for an entity 120, the cohort engine 189 may first determine if the other entities 120 in the cohort 289 of the entity 120 are also experiencing similarly poor performance metrics 287. If so, the cause of the poor performance may not be specific to the entity 120 but may lie with the image streaming application 170 or some other common factor such as an ISP.

Conversely, if the other entities 120 in the cohort 289 of the entity 120 are not also experiencing similarly poor performance metrics 287, then the problem may be associated with the computing environment 150 of the entity 120 experiencing the performance issues. In such cases the performance engine 180 may dispatch a representative to the entity 120 to troubleshoot the issue.

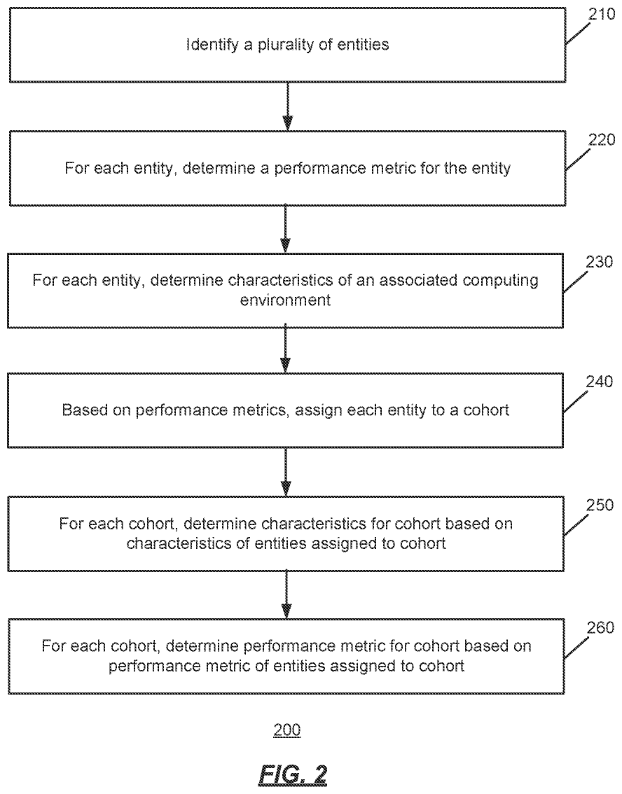

FIG. 2 is an illustration of an example method for assigning entities to cohorts. The method 200 may be implemented by the performance engine 180.

At 210, a plurality of entities is identified. The plurality of entities 120 may be identified by the performance engine 180. In some embodiments, the identified entities 120 may be users of a cloud-based application such as the image streaming application 170.

At 220, for each entity, a performance metric is determined for the entity. The performance metric 287 may be determined for each entity 120 by the metric engine 187. The performance metric 287 determined for an entity 120 may be a measure of the performance of the image streaming application 170 for the entity 120. The performance metrics 287 may include throughput, response time, bandwidth, and latency. Other performance metrics 287 may be measured.

At 230, for each entity, characteristics of a computing environment are determined for the entity. The characteristics 285 of the computing environment 150 associated with an entity 120 may be determined by the characteristics engine 185. The characteristics 285 may include location characteristics, network characteristics, workload characteristics, and computing resource characteristics.

At 240, based on the performance metrics, each entity is assigned to a cohort. The entities 120 may be assigned to cohorts 289 by the cohorts engine 189 based on the determined performance metrics 287 such that the entities 120 assigned to a cohort 289 all have similar (e.g., with a threshold percentage of) performance metrics 287.

At 250, for each cohort, characteristics for the cohort are determined based on entities assigned to the cohort. The characteristics 285 for a cohort 289 may be determined by the cohort engine 189. In some embodiments, the cohort engine 189 may, for each cohort 289, determine characteristics 285 common to some or all of the entities 120 assigned to the cohort 289 and assign the determined characteristics 285 to the cohort 289.

At 260, for each cohort, performance metrics for each cohort are determined based on entities assigned to the cohort. The performance metric 287 for a cohort 289 may be determined by the cohort engine 189. In some embodiments, the cohort engine 189 may, for each cohort 289, determine the average performance metric 287 for some or all of the entities 120 assigned to the cohort 289 and assign the determined characteristics 285 to the cohort 289.

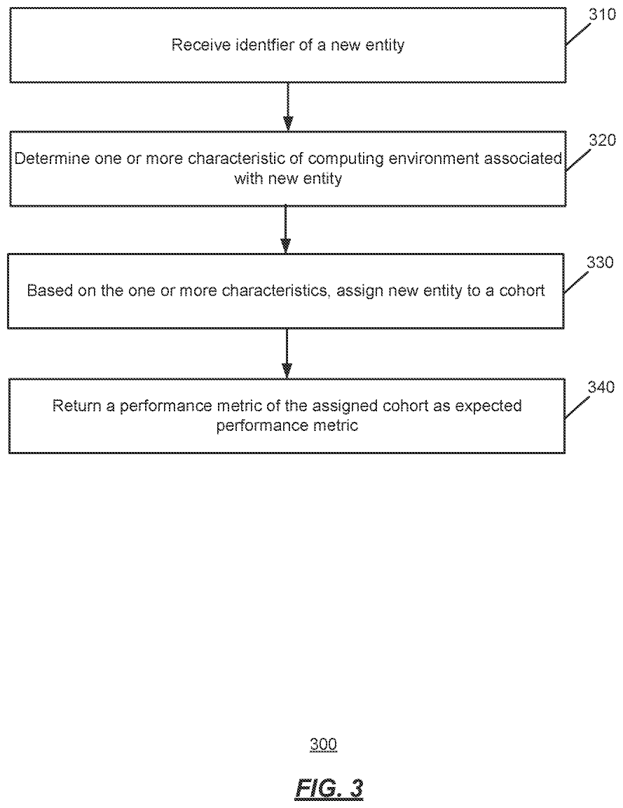

FIG. 3 is an illustration of an example method for estimating a performance metric for an entity based on cohorts. The method 300 may be implemented by the performance engine 180.

At 310, an identifier of a new entity is received. The identifier of a new entity 120 may be received by the performance engine 180. In some embodiments, the new entity 120 may be a prospective customer of the image streaming application 170 and would like estimates regarding what performance metrics 287 can be expected for the new entity 120.

At 320, one or more characteristics of the computing environment associated with the new entity are determined. The one or more characteristics of the computing environment 150 may be determined by the characteristics engine 185. For example, the new entity 120 may complete a survey or questionnaire and the one or more characteristics 285 may be infer from or extracted from the survey or questionnaire.

At 330, based on one the one or more characteristics, the new entity is assigned to a cohort. The new entity may be assigned to a cohort 289 by the cohort engine 189. In some embodiments, the cohort engine 189 may determine a cohort 289 with characteristics 285 that are similar to the one or more characteristics 285 of the new entity 120. The new entity may then be assigned to the determined cohort 289.

At 340, a performance metric of the assigned cohort is returned at the expected performance metric for the cohort. The performance metric 287 may be returned to the new entity 120 by the performance engine 180. The entity 120 can expect to achieve similar performance metrics 287 should they decide to use the image streaming application 170.

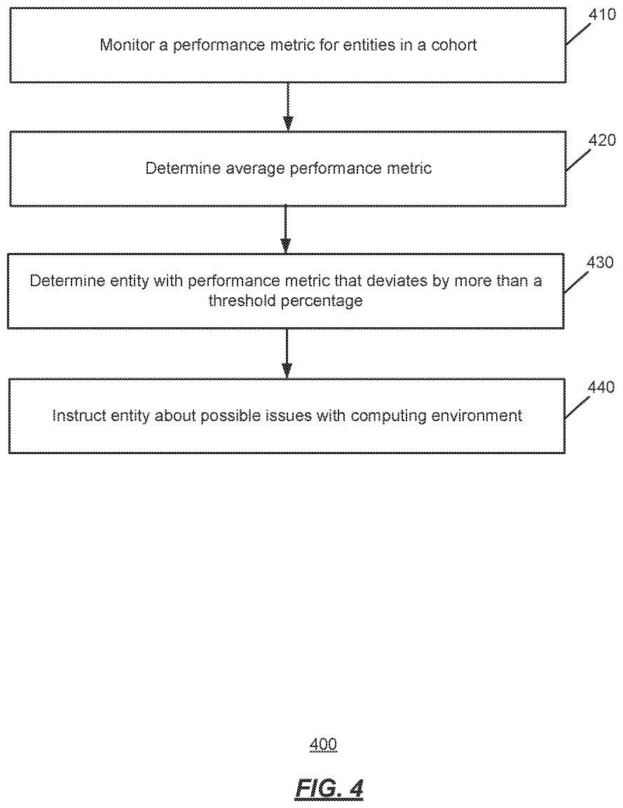

FIG. 4 is an illustration of an example method 400 for identifying entities with computing environment issues. The method 400 may be implemented by the performance engine 180.

At 410, a performance metric is monitored for each entity in a cohort. The performance metric 287 may be monitored by the metrics engine 187. In some embodiments, an application or network appliance may be installed at each entity 120 that measures one or more performance metrics 287 for the entities 120 and the image streaming application 170. Alternatively or additionally, the metrics engine 187 may monitor the performance metric 287 using data received from the image streaming application 170.

At 420, an average performance metric is determined for the cohort. The average performance metric 287 for the entities 120 in the cohort 289 may be determined by the metrics engine 187 using each performance metric 287 determined for the entities 120. The average performance metric 287 may be one or more of a mean, median, or mode, for example.

At 430, an entity with a performance metric that deviates from the average by more than a threshold percentage is determined. The entity 120 may be determined by the metrics engine 187. The threshold percentage may be set by a user or administrator. An example threshold percentage is 20%. A performance metric 287 that deviates from the average performance metric 287 may indicate that the associated entity 120 is experiencing a technical issue with their computing environment 150 that is not affecting the other entities 120 in the cohort 289.

At 440, the entity is instructed about a possible issue with their computing environment. The entity 120 may be instructed by the performance engine 180. For example, the performance engine 180 may send an administrator or contact associated with the entity 120 a message indicating the possible performance issue or may dispatch a technician to a location associated with the entity 120 for troubleshooting.

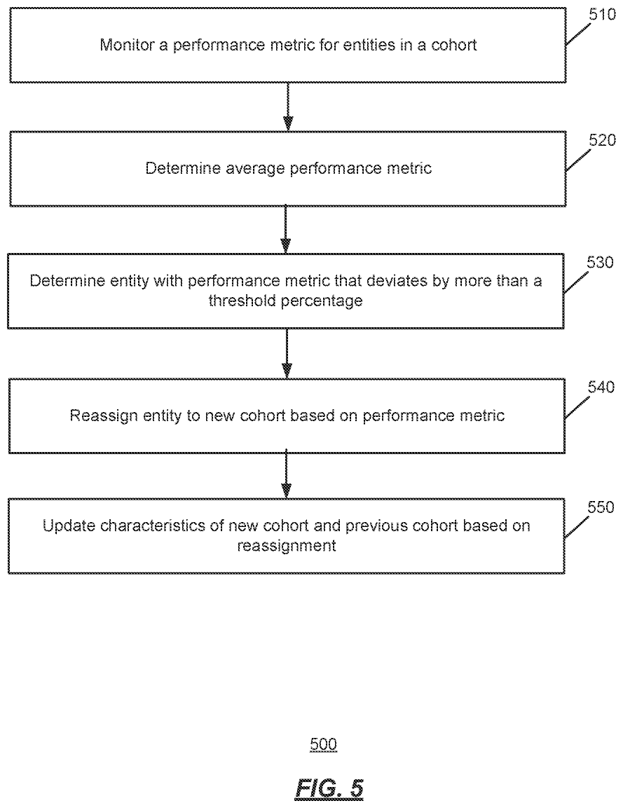

FIG. 5 is an illustration of an example method 500 for reassigning entities based on cohorts. The method 500 may be implemented by the performance engine 180.

At 510, a performance metric is monitored for each entity in a cohort. The performance metric 287 may be monitored by the metrics engine 187.

At 520, an average performance metric is determined for the cohort. The average performance metric 287 for the entities 120 in the cohort 289 may be determined by the metrics engine 187 using each performance metric 287 determined for the entities 120.

At 530, an entity with a performance metric that deviates from the average by more than a threshold percentage is determined. The entity 120 may be determined by the metrics engine 187. The threshold percentage may be set by a user or administrator. An example threshold percentage is 30%. A performance metric 287 that is below the average performance metric 287 may indicate that the associated entity 120 should be assigned to a new cohort 289.

At 540, the entity is reassigned to a different cohort 289. The entity 120 may be reassigned to a different cohort 120 by the cohort engine 189. In some embodiments, the cohort engine 189 may reassign the entity 120 to a different cohort by comparing the performance metric 287 of the entity 120 to the average performance metrics 287 of each of the cohorts 289. The cohort engine 189 may reassign the entity 120 to the cohort 289 with an average performance metric 287 that most closely matches the performance metric 287 of the entity 120.

In some embodiments, rather that immediately reassign the entity to a different cohort, the cohort engine 189 may continue to monitor the performance metric 287 of the entity versus the performance metric 287 of the associated cohort 289 over some window of time (e.g., one day, one week, or two weeks). If the performance metric 287 of the entity deviates from the performance metric 287 of the cohort 289 regularly (e.g., >80% of the time) over the course of the window, then the cohort engine 189 may reassign the entity to a different cohort 289. The size of the window and the amount of deviation may be set by a user or administrator.

At 550, characteristics of the new cohort and previous cohort are updated based on reassignment. The characteristics 285 of the cohorts 289 may be updated by the characteristics engine 185. In some embodiments, the characteristics engine 185 may update the characteristics 285 of the old cohort 289 by removing some or all of the characteristics 285 associated with the computing environment 150 of the entity 120 from the old cohort 289. The characteristics engine 185 may update the characteristics 285 of the new cohort 289 by adding some or all of the characteristics 285 associated with the computing environment 150 of the entity 120 added to the new cohort 289.

FIG. 6 shows an example computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 6, an example system for implementing aspects described herein includes a computing device, such as computing device 600. In its most basic configuration, computing device 600 typically includes at least one processing unit 602 and memory 604. Depending on the exact configuration and type of computing device, memory 604 may be volatile (such as random access memory (RAM)), non-volatile (such as read-only memory (ROM), flash memory, etc.), or some combination of the two. This most basic configuration is illustrated in FIG. 6 by dashed line 606.

Computing device 600 may have additional features/functionality. For example, computing device 600 may include additional storage (removable and/or non-removable) including, but not limited to, magnetic or optical disks or tape. Such additional storage is illustrated in FIG. 6 by removable storage 608 and non-removable storage 610.

Computing device 600 typically includes a variety of computer readable media. Computer readable media can be any available media that can be accessed by the device 600 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 604, removable storage 608, and non-removable storage 610 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer storage media may be part of computing device 600.

Computing device 600 may contain communication connection(s) 612 that allow the device to communicate with other devices. Computing device 600 may also have input device(s) 614 such as a keyboard, mouse, pen, voice input device, touch input device, etc. Output device(s) 616 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although example implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
identifying a plurality of entities by a computing device, wherein each device is associated with a computing environment;
for each entity of the plurality of entities, determining a performance metric associated with the computing environment by the computing device;
for each entity of the plurality of entities, determining a plurality of characteristics associated with the computing environment;
based on the performance metric associated with each entity of the plurality of entities, assigning each entity to a cohort of a plurality of cohorts;
for each cohort of the plurality of cohorts, determining a plurality of characteristics associated with the cohort based on the plurality of characteristics of the computing environments associated with each entity assigned to the cohort;
for each cohort of the plurality of cohorts, determining a performance metric for the cohort based on the performance metrics determined for each entity assigned to the cohort by the computing device;
determining that the performance metric for at least one entity assigned to at least one cohort of the plurality of cohorts deviates from the performance metric for the at least one cohort by more than a threshold percentage by the computing device; and
in response to the determination, instructing the at least one entity that there may be a performance issue with respect to the computing environment associated with the at least one entity by the computing device.

2. The method of claim 1, wherein the plurality of characteristics associated with the computing environment comprise network characteristics, network characteristics, location characteristics, workload characteristics, and computing resource characteristics.

3. The method of claim 1, wherein the performance metric is a performance metric associated with an image streaming application.

4. The method of claim 1, wherein determining a performance metric for the cohort based on the performance metrics determined for each entity assigned to the cohort comprises:
determining an average performance metric based on the determined performance metrics for some or all of the entities assigned to the cohort; and
determining the performance metric for the cohort using the average performance metric.

5. The method of claim 1, further comprising:
receiving an identifier of a new entity by the computing device, wherein the new entity is not part of the plurality of entities;
determining one or more characteristics of a computing environment associated with the new entity by the computing device;
based on the determined one or more characteristics of the computing environment associated with the new entity, assigning the new entity to a cohort of the plurality of cohorts by the computing device; and
returning the performance metric for the cohort assigned to the new entity as an expected performance metric for the entity by the computing device.

6. The method of claim 1, further comprising:
in response to determining that the performance metric for the at least one entity assigned to the at least one cohort of the plurality of cohorts deviates from the performance metric for the at least one cohort by more than the threshold percentage, reassigning the at least one entity to a different cohort of the plurality of cohorts.

7. The method of claim 6, further comprising associating some or all of the characteristics of the computing environment associated with the at least one entity to the different cohort.

8. The method of claim 1, wherein determining the one or more characteristics of the computing environment associated with the new entity comprises providing a questionnaire to the new entity and determining the one or more characteristics of the computing environment associated with the new entity based on a response to the questionnaire from the new entity.

9. A system comprising:
at least one computing device; and
a computer-readable medium with computer-executable instructions stored thereon that when executed by the at least one computing device cause the at least one computing device to:
identify a plurality of entities, wherein each device is associated with a computing environment;
for each entity of the plurality of entities, determine a performance metric associated with the computing environment;
for each entity of the plurality of entities, determining a plurality of characteristics associated with the computing environment;
based on the performance metric associated with each entity of the plurality of entities, assign each entity to a cohort of a plurality of cohorts;
for each cohort of the plurality of cohorts, determine a plurality of characteristics associated with the cohort based on the plurality of characteristics of the computing environments associated with each entity assigned to the cohort;
for each cohort of the plurality of cohorts, determine a performance metric for the cohort based on the performance metrics determined for each entity assigned to the cohort;
determine that the performance metric for at least one entity assigned to at least one cohort of the plurality of cohorts deviates from the performance metric for the at least one cohort by more than a threshold percentage; and
in response to the determination, instruct the at least one entity that there may be a performance issue with respect to the computing environment associated with the at least one entity.

10. The system of claim 9, wherein the plurality of characteristics associated with the computing environment comprise network characteristics, network characteristics, location characteristics, workload characteristics, and computing resource characteristics.

11. The system of claim 9, wherein the performance metric is a performance metric associated with an image streaming application.

12. The system of claim 9, wherein determining a performance metric for the cohort based on the performance metrics determined for each entity assigned to the cohort comprises:
determining an average performance metric based on the determined performance metrics for some or all of the entities assigned to the cohort; and
determining the performance metric for the cohort using the average performance metric.

13. The system of claim 9, further comprising computer-executable instructions that when executed by the at least one computing device cause the at least one computing device to:
receive an identifier of a new entity, wherein the new entity is not part of the plurality of entities;
determine one or more characteristics of a computing environment associated with the new entity;
based on the determined one or more characteristics of the computing environment associated with the new entity, assign the new entity to a cohort of the plurality of cohorts; and
return the performance metric for the cohort assigned to the new entity as an expected performance metric for the entity.

14. The system of claim 9, further comprising computer-executable instructions that when executed by the at least one computing device cause the at least one computing device to:
in response to the determination that the performance metric for the at least one entity assigned to the at least one cohort of the plurality of cohorts deviates from the performance metric for the at least one cohort by more than the threshold percentage, reassign the at least one entity to a different cohort of the plurality of cohorts.

15. The system of claim 14, further comprising associating some or all of the characteristics of the computing environment associated with the at least one entity to the different cohort.

16. A non-transitory computer-readable medium with computer-executable instructions stored thereon that when executed by at the least one computing device cause the at least one computing device to:
identify a plurality of entities, wherein each device is associated with a computing environment;
for each entity of the plurality of entities, determine a performance metric associated with the computing environment;
for each entity of the plurality of entities, determining a plurality of characteristics associated with the computing environment;
based on the performance metric associated with each entity of the plurality of entities, assign each entity to a cohort of a plurality of cohorts;
for each cohort of the plurality of cohorts, determine a plurality of characteristics associated with the cohort based on the plurality of characteristics of the computing environments associated with each entity assigned to the cohort;
for each cohort of the plurality of cohorts, determine a performance metric for the cohort based on the performance metrics determined for each entity assigned to the cohort;
determine that the performance metric for at least one entity assigned to at least one cohort of the plurality of cohorts deviates from the performance metric for the at least one cohort by more than a threshold percentage; and
in response to the determination, instruct the at least one entity that there may be a performance issue with respect to the computing environment associated with the at least one entity.

17. The non-transitory computer-readable medium of claim 16, wherein the plurality of characteristics associated with the computing environment comprise network characteristics, network characteristics, location characteristics, workload characteristics, and computing resource characteristics.

18. The non-transitory computer-readable medium of claim 16, wherein the performance metric is a performance metric associated with an image streaming application.

19. The non-transitory computer-readable medium of claim 16, wherein determining a performance metric for the cohort based on the performance metrics determined for each entity assigned to the comprises:
determining an average performance metric based on the determined performance metrics for some or all of the entities assigned to the cohort; and
determining the performance metric for the cohort using the average performance metric.

20. The non-transitory computer-readable medium of claim 16, further comprising computer-executable instructions that when executed by the at least one computing device cause the at least one computing device to:
receive an identifier of a new entity, wherein the new entity is not part of the plurality of entities;
determine one or more characteristics of a computing environment associated with the new entity;
based on the determined one or more characteristics of the computing environment associated with the new entity, assign the new entity to a cohort of the plurality of cohorts; and
return the performance metric for the cohort assigned to the new entity as an expected performance metric for the entity.
